(19) United States
(12) Patent Application Publication
(10) Pub. No.: US 2009/0082704 A1
(43) Pub. Date: Mar. 26, 2009

(54) OSCILLATING FEET SUPPORTING APPARATUS

(76) Inventor: Avraham NOV, Moshav Mazor (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/860,749

(22) Filed: Sep. 25, 2007

(51) Int. Cl. A61H 1/00; A61H 23/02

(52) U.S. Cl. 601/27; 601/46

(57) ABSTRACT

A feet-supporting apparatus (FSA) comprising of three independent movement-mechanisms that enable moving a feet-supporting platform for massaging of a user's feet that are placed on the platform, where the platform is connected to the mechanisms through a main-axis-member defining a main-axis that is substantially perpendicular to a floor-plane. The three mechanisms may be a leverage-mechanism, a tilting-mechanism and a rotation-mechanism, where a separate motor may independently operate each mechanism. The rotating-mechanism may enable oscillating the footrest platform by rotating at least two bearings that tangentially interface the bottom side of the platform around the main-axis, where each bearing may be seated at a different distance from the floor-plane and/or from a wheels-base, which is a platform holding cogwheels that rotate said bearings.

### FIELD OF THE INVENTION

The present invention generally relates to the field of feet supporting apparatuses and more particularly, to oscillating feet supporting apparatuses.

### BACKGROUND OF THE INVENTION

modern age forces many people around the world to work in working environments that the human body has not yet adapted to in an optimal manner. Many people have to sit in front of a computer, a desk or a counter, for example, for five to twelve hours a day where the height of the desk and the chair may not always optimize the user's sitting posture to allow the minimal applying of strain on the user's back and neck muscles.

The substantially optimal sitting posture may be when the user's feet are placed flat on the floor or any other supporting surface parallel to the plane of the floor and the table or desk platform is low enough (or alternatively—the chair may be raised high enough compared to the desk's plane) to allow the user's arms to create a substantially right angle between each upper arm and forearm of the user. These proportions may be hard to achieve since different people of different heights and limbs proportions may require different desk's heights or chair positions.

Another problem that may be caused by sitting long hours is that the user may not move his/her feet for these hours. This may cause all kinds of physical problems due to lower supply of blood to the feet area. This can be solved by enabling the user to either move his/her feet by getting off the chair and walking every once in a while but many users fail to follow this advise and may forget or be prevented from exercising their feet and legs for many reasons, some for reasons they cannot control.

A patent number U.S. Pat. No. 6,285,144, by Shih Chao-Ming discloses a foot-massage machine enabling to shift a movable piece (“eccentric block) vertically and horizontally on a foot-rest machine to massage the user's foot by allowing the user to place his foot upon the movable piece.

A patent application number US2004210168, by Takizawa Shigeo and Takizawa Kioko discloses a lower limbs training device that can selectively move back and forth and rock vertically.

A patent number U.S. Pat. No. 4,953,541, by Parker J R Alonzo E. discloses a passive exercising apparatus that includes a movable frame mounted on a table enabling the table to move in three types of movements: lowering and lifting, pivoting around two axes.

A patent application number US2003045818, by Huang Shung Tsai discloses an exerciser enabling to rotate foot supporting “linking members” to deflect and swing up and down.

A patent number U.S. Pat. No. 5,183,308, by Koga Yoshitaka, Sugiura Sadao and Aisin Seiki discloses a footrest apparatus enabling to link to a seat, where the footrest enables moving up and down in a single tilting direction.

### SUMMARY OF THE INVENTION

A feet-supporting apparatus (FSA) comprising of three independent movement-mechanisms that may enable moving a feet-supporting platform for massaging of a user's feet placed on the platform, where the platform may be connected to the mechanisms through a main-axis-member defining a main-axis that is substantially perpendicular to a floor-plane (upon which the apparatus is placed). The three mechanisms may be a leverage-mechanism, a tilting-mechanism and a rotation-mechanism, where a separate motor may independently operate each mechanism. The rotating-mechanism may enable oscillating the footrest platform by rotating at least two bearings that tangentially interface the bottom side of the platform around the main-axis, where each bearing may be seated at a different distance from the floor-plane and/or from a wheels-base, which is a platform holding cogwheels that rotate said bearings. The platform may oscillate in a multidirectional tilting movement (shortly referred to as the oscillation movement) due to the height differences of the bearings that rotate underneath it.

The levering movement refers to a lowering and lifting movement of the platform along the main-axis. This movement may be achieved by two sets of parallel triangular frames where each frame comprises two levers connected through a hinge that may also connect the other pair. One of the levers of each pair may slide in a sliding track at the base of the FSA where once sliding forwards and backwards, the FSA may be lowered and lifted along the main axis.

The single directional tilting movements (enabled by the tilting-mechanism) is the tilting of the platform by rotating the platform substantially along a single arched orbit around each central point positioned along the main-axis. The tilting movement may be achieved by rotating a tilting-arm that enables tilting of the platform.

The multi-directional tilting movement can be defined as the lowering of any one side of the platform towards the floor-plane while the opposite side to the lowered side may automatically be lifted. The combination of tilting movements in a multiplicity of directions—meaning a multiplicity of arched-orbits centered at a point(s) along the main-axis is defined herein as “the oscillation movement” of the platform.

According to embodiments of the invention, each motor may be controlled through a switch and the three switches may all be operated through a main control box.

Additionally, the control box may be operatively associated with a remote control through which each motor may be controlled separately and/or control the power level of the motors according to predefined programs.

According to alternative embodiments of the invention, the FSA may only comprise the rotation-mechanism enabling the oscillation of the platform.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein.

FIG. 1 is a schematic illustration of a side view of an oscillating feet-supporting apparatus, according to some embodiments of the invention.

FIG. 2 is a schematic illustration of a top view of an oscillating feet-supporting apparatus, according to some embodiments of the invention.

FIG. 3 is a schematic illustration of a right side-view of the movements' mechanisms of the feet-supporting apparatus, according to some embodiments of the invention.

FIG. 4 is a schematic illustration of a left side-view of the movements' mechanisms of the feet-supporting apparatus, according to some embodiments of the invention.

FIG. 5 is a schematic illustration of a right side-view leverage-mechanism of the feet-supporting apparatus, according to some embodiments of the invention.

FIG. 6 is a schematic illustration of a left side-view leverage-mechanism of the feet-supporting apparatus, according to some embodiments of the invention.

FIG. 7 is a schematic illustration of a left side-view of a tilting-mechanism of the feet-supporting apparatus, according to some embodiments of the invention.

FIG. 8 is a schematic illustration of the right side-view of a tilting mechanism of the feet-supporting apparatus, according to some embodiments of the invention.

FIG. 9 is a schematic illustration of the left side-view of a rotation-mechanism of the feet-supporting apparatus, according to some embodiments of the invention.

FIG. 10 is a schematic illustration of a right-side view of a rotation-mechanism of the feet-supporting apparatus, according to some embodiments of the invention.

FIG. 11 is a schematic illustration of an adjustable swaying member of a platform of a feet-supporting apparatus, enabling to adjust to the platform's oscillations, according to some embodiments of the invention.

The drawings together with the description make apparent to those skilled in the art how the invention may be embodied in practice.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

### DETAILED DESCRIPTIONS OF SOME EMBODIMENTS OF THE INVENTION

The present invention discloses a feet-supporting apparatus (FSA) 100 that enables to oscillate a cover-platform 101 of the FSA 100 in various tilting, oscillating and levering directions.

The levering movement refers to a lowering and lifting movement of the platform 101 along a main-axis 30 which is substantially perpendicular to a floor-plane 40 upon which the FSA 100 may be placed.

The single directional tilting movements can be referred to tilting of the platform by rotating the platform 101 substantially along a single arched orbit around each central point positioned along the main-axis 30.

The multi-directional tilting movement can be defined as the lowering of any one side of the platform 101 towards the floor-plane 40 while the opposite side to the lowered side may automatically be lifted. The combination of tilting movements in a multiplicity of directions meaning a multiplicity of arched-orbits centered along the main-axis 30 is defined herein as “the oscillation movement” of the platform 101.

Oscillating the platform 101 of the FSA 100 may be used for massaging a user's feet or foot. The user may seat in front of the FSA 100 and lay his/her feet upon the platform 101 where the oscillation movement of the platform 101 may be automatically and electronically controlled through, for example, switches 50 seated in the FSA 100 that may he operatively associated with a remote control unit. Alternatively or additionally, the user himself may be oscillating the FSA 100 by using his/her feet applying physical strain to exercise the feet's muscles.

While the description below contains many specifications these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

Reference in the specification to “one embodiment”, “an embodiment”, some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent of similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

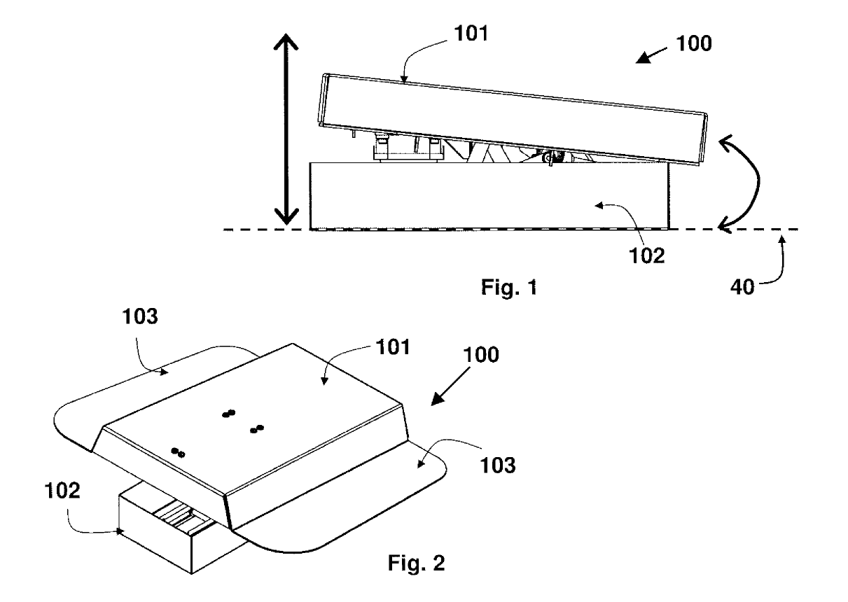

FIG. 1 and FIG. 2 schematically illustrate a feet supporting apparatus (FSA) 100, according to some embodiments of the invention. According to these embodiments, the FSA 100 may comprise a cover platform 101 shaped as a flat plate having two side-wings 103 that are jointly configured with the platform 101, where the wings 103 may be seated substantially parallel and lower from the upper plane of the platform 101, as illustrated in FIG. 2. To esthetically hide the inside machinery and parts of the mechanisms enabling the oscillation, a base-housing 102 may enable concealing at least some of the inside parts of the FSA 100.

The Following figures illustrate at least some of the mechanisms and parts that are seated inside the housing 102 and underneath the platform 101 of the FSA 100, therefore the housing 102 and platform 101 may be removed from some of the drawings for illustrative purposes, to show the internal parts constructing the FSA 100.

The FSA 100, according to the embodiments illustrated in FIGS. 1-11, enables three movements-mechanisms:
a leverage mechanism comprising a leverage-motor 130 that may enable lifting and lowering the platform 101 along the main-axis 30 that may be substantially perpendicular to the floor-plane 40, where the apparatus is placed;
a single-directional tilting mechanism comprising a tilting motor 140 enabling to tilt the platform 101 towards and away from the floor-plane 40 through a singe-direction (front and back or right and left), where the lowering of one side of the platform 101 (e.g. the front) towards the floor-plane 40 automatically tilts the opposite side (e.g. the back) of the platform 101 at the opposite direction;
a rotation-mechanism comprising a rotation-motor 120 enabling to oscillate the platform 101 in a multidirectional tilting movement by rotating of bearings 121 around the main-axis 30.

According to embodiments of the invention, the rotation-mechanism may enable oscillating the platform 101 in a multiple-tilting movement, without rotating the platform 101 around the main-axis 30 by rotating the un-equally-distanced-bearings 121 around the main-axis 30 whereby enabling to massage the user's, when the user's feet are placed on said platform 101. The rotation-mechanism, the tilting-mechanism and the leverage-mechanism, may all be operating on the same platform 101 simultaneously by operating the three motors, enabling the platform 101 to be lowered, lifted and tilted in relation to the main-axis 30, where the rotation of the bearings 121 when they change their heights enables the oscillation movement of said platform 101 while it is lowered/lifted and/or tilted by the other mechanisms.

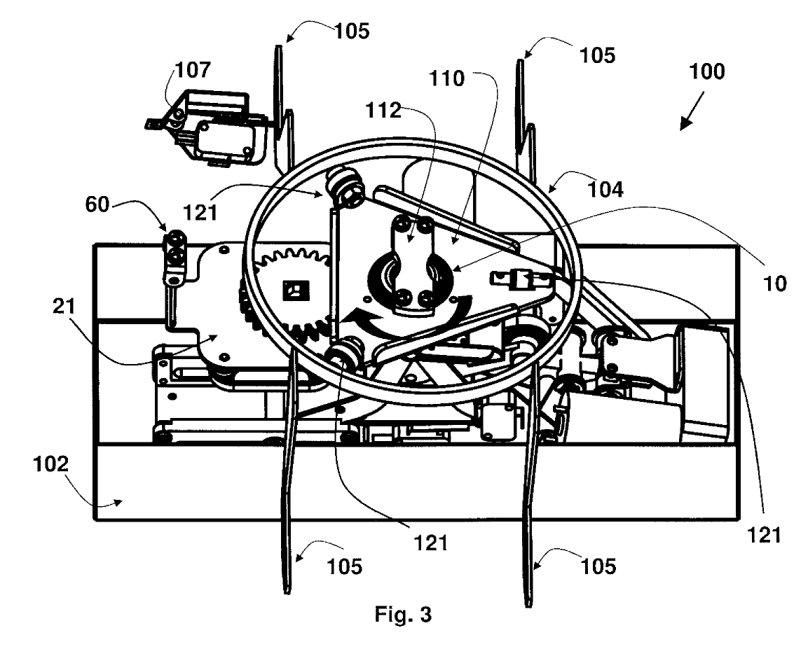

According to some embodiments of the invention, as illustrated in FIG. 3, the platform 101 and wings 103 may be seated on a holding-ring 104 and wing-holders 105 respectively, where the ring 104 may be jointly configured with the wing-holders 105; the ring 104 may be jointly configured with the platform 101; and the wing-holders 105 jointly configured with the wings 103. The bearings 121 may be seated in a bearings-base 110, which may be shaped as a triangular base 110, for example, enabling wheel like bearings 121 to roll within niches designed to hold the bearings 121. The ring 104 and wing-holders 105 may be jointly configured with the platform 101 as a single molded piece.

The platform 101 may be connected substantially at its center to a main-axis-member 10 that may be held affixed along the main-axis 30, through any connecting and/or fastening means known in the art.

Additionally, a control box 107 may be connected to the housing 102. The control box 107 may be operatively associated with switches 50 that control each motor where a remote control may be operatively associated with the control box 107 enabling the user to set each motor's optional controllable features (direction, speed etc.) from afar.

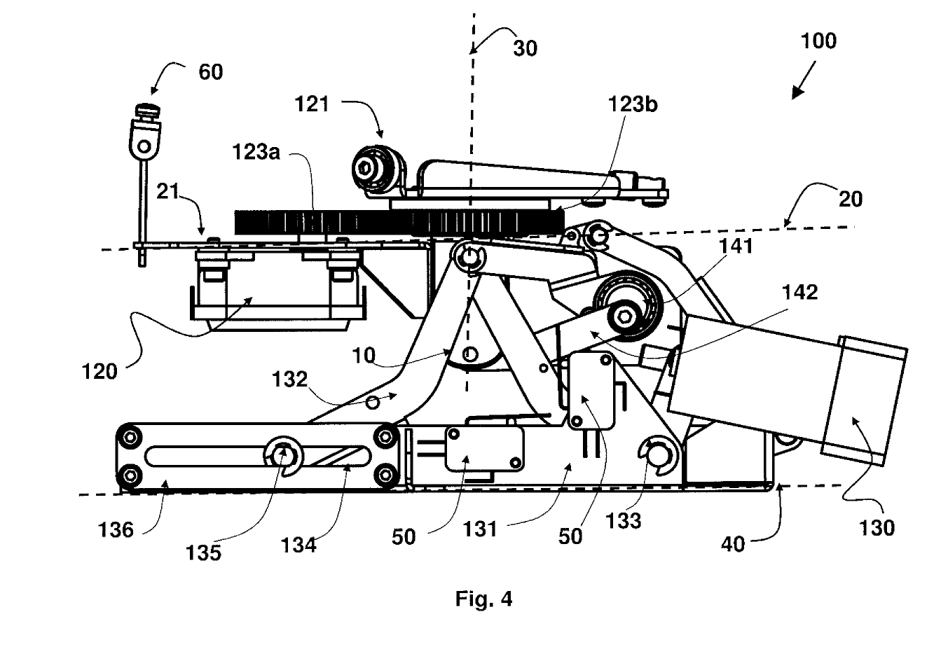

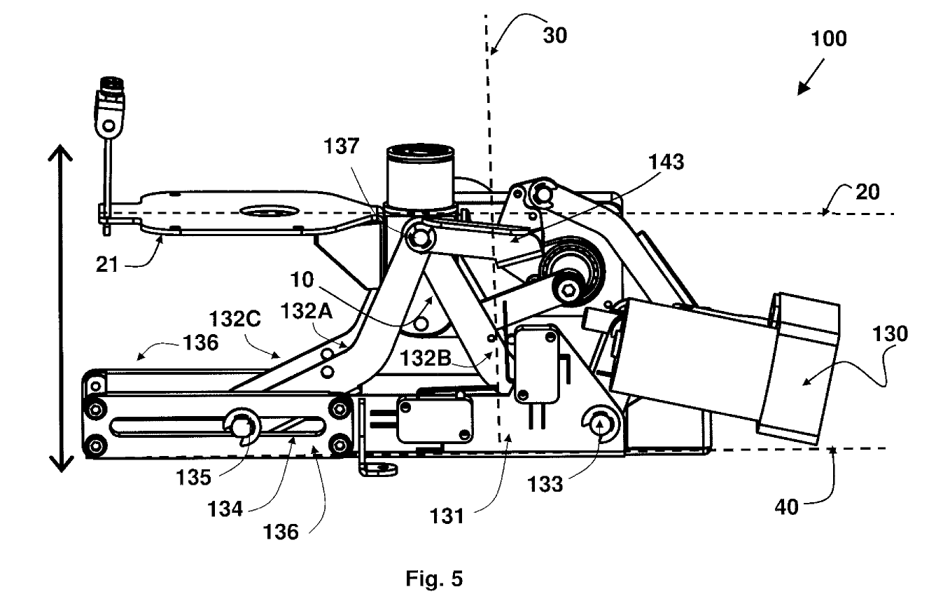

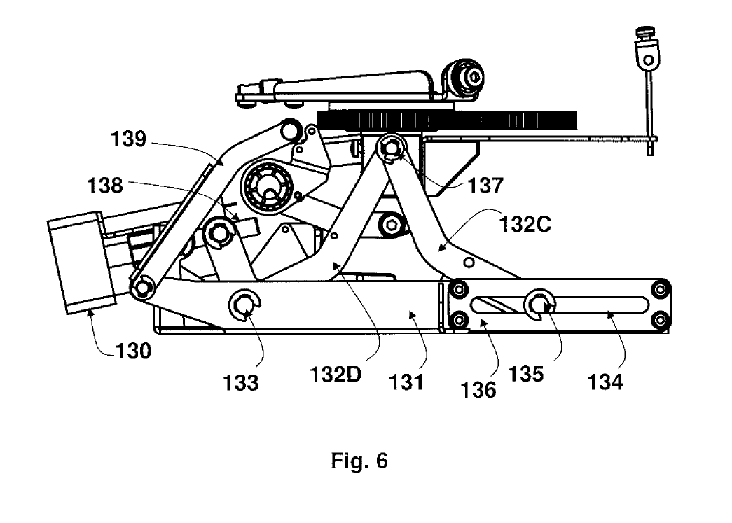

According to embodiments of the invention, as illustrated in FIG. 4, the leverage-mechanism may include the leverage-motor 130 and two sets of parallel curved-levers 132 where each two unparallel curved-levers 132A and 132B or 132C and 132D as illustrated in FIG. 4, FIG. 5 and FIG. 6, are movably connected by, for example, a hinge 137 where each unparallel pair of levers 132 create a triangle-like frame and the hinge 137 allows the aperture of the frame to increase and decrease whereby lowering and lifting the platform 101 connected to the main-axis-member 10 in a vertical direction to the floor-plane 40.

FIG. 5 and FIG. 6 schematically illustrate the right and left side-views of the FSA 100 leverage-mechanism, according to some embodiments of the invention. The parallel curved-levers 132B and 132D may he rotatably-connected to a rotating-hinge 133 enabling to rotate these levers 132B and 132D forwards and backwards. Since levers 132B and 132D are movably connected to levers 132A and 132C respectively through another rotating hinge 137 once the leverage-motor 130 rotates hinge 137 the levers 132A and 132C may automatically slide forward and backward accordingly. To control the sliding track a track 136 comprising an opening 134 that enables receiving the connecting rod 135 of the curved-levers 132A and 132C may be installed at each side of those levers 132A, C. The leverage-motor 130 may rotate a shaft 138 that may enable pushing a set of two parallel curved-levers 132B and 132D forwards and backwards through, for example, a set of bearings. Once the levers 132B and 132D are pushed, the levers 132A and 132C may automatically slide along the track's 136 opening 134 enabling lowering and lifting the platform 101 along with the entire FSA 100 along the main-axis 30. The hinge 133 may be fasted to a base 131 to allow holding and balancing the leverage-mechanism as well as the FSA 100.

Additionally, as illustrated in FIG. 6, the left side of the base 131 may be rotatably-connected to an arm 139, which may be a piece that connects to the tilting-motor 140 to allow stabilizing the main-axis-member 10 when the entire FSA 100 is lifted or lowered by the leverage-mechanism.

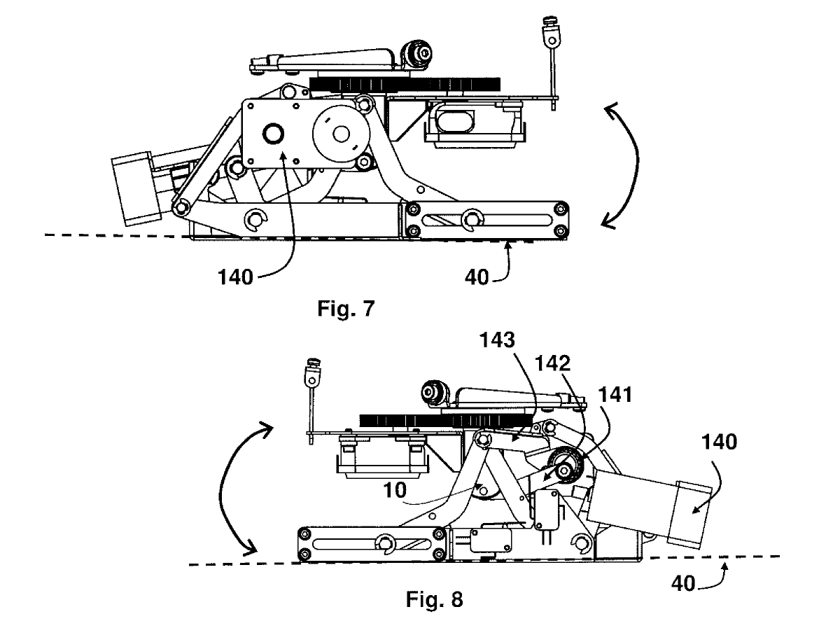

FIG. 7 and FIG. 8 schematically illustrate the titling mechanism through the left and right side-views of the FSA 100, according to some embodiments of the invention. The tilting-motor 140 may be connected to a tilting-shaft 141 enabling to rotate according to the motor's 140 rotating speed and power. The tilting-shaft 141 may be rotatably-connected to a tilting-arm 142 where the rotating of the tilting-shaft 141 enables rotating the arm 142. The arm 142 may be connected to a connector 143 connecting to a wheels-base 21 that may be connected to the main-axis-member 10 enabling to hold the main-axis-member 10 perpendicular to the tilting plane 20. According to embodiments of the invention, the arm 142 may be connected to the circumference surface of the shaft's 141 side enabling to tilt the FSA 100 back and forth without having to convert the rotation direction of the tilting-shaft 141.

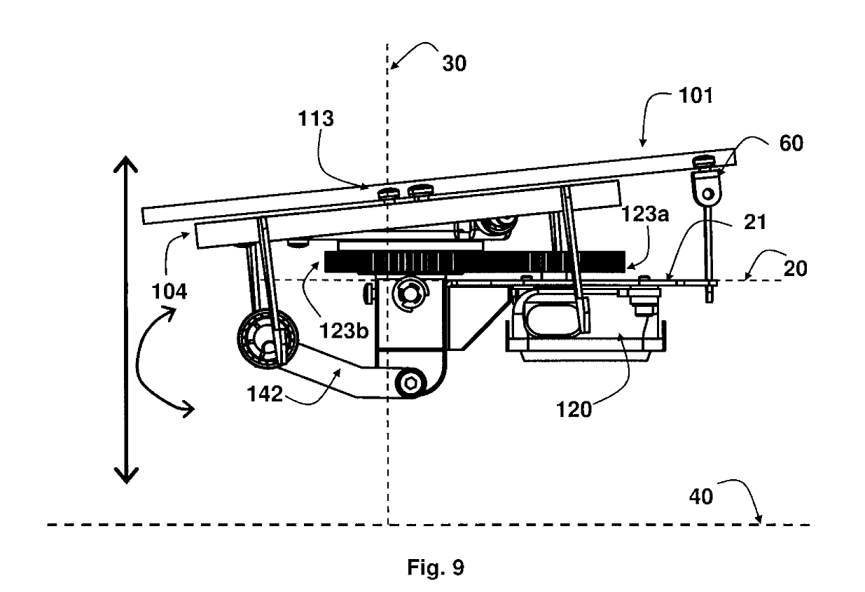

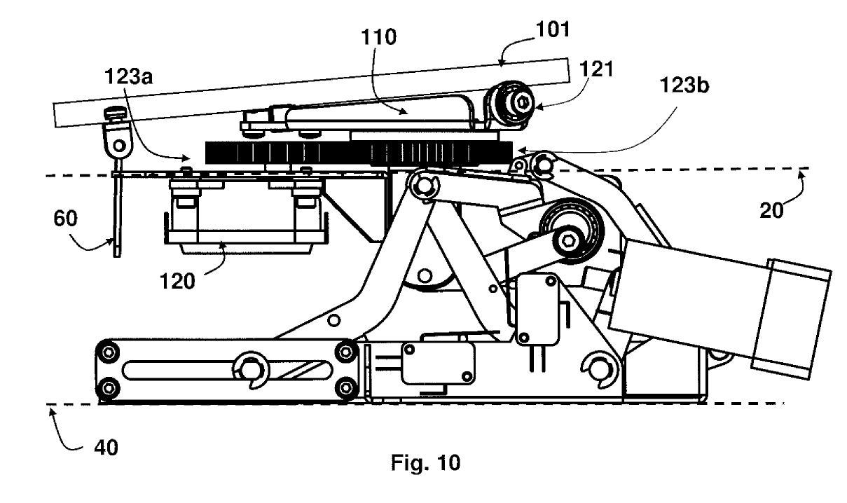

FIG. 9 and FIG. 10 schematically illustrate the rotating mechanism that enables the oscillating movement of the platform 101, according to some embodiments of the invention. At least two rotating-bearings 121 seated at different distances from the floor-plane 40 by being affixed at different distances from the wheels-base 21, which is a connecting piece that may be fastened to the main-axis-member 10 and substantially parallel to the tilting plane 20 that connects to cogwheels 123 that rotate the bearings 121. The bearings 121 may enable rotating around their own axis in a planetary movement, additionally to rotating around the main-axis 30, where the bearings 121 may hold the platform 101 by tangentially interfacing with the bottom surface of the platform 101 while sliding underneath it without rotating the platform 101 itself and where at least some of the rotation-bearings 121 may be affixed to the FSA 100 at different distances from the floor-plane 40 and/or to the tilting plane 20.

According to embodiments of the invention, as illustrated in FIG. 9 and FIG. 10 the rotation-motor 120 may be affixed to the wheels-base 21. The rotation-motor 120 may enable rotating a first cogwheel 123A through a shaft, where the first cogwheel 123A may rotate a first rotation-bearing 121 as well as rotating a second cogwheel 123B that may eventually rotate a second rotation-bearing 121.

Additionally or alternatively, other sets of cogwheels 123 rotating additional bearings 121 may be installed to the systems, according to embodiments of the invention.

According to some embodiments of the invention, as illustrated in FIG. 9 and FIG. 10, the platform 101 may be fastened to the bearings-base 110 the through fastening means 113 such as screwing means, for example.

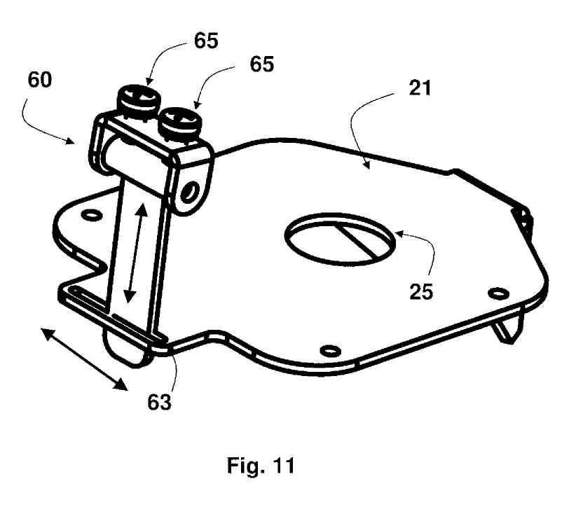

Additionally, the platform 101 may also connect to an adjustable swaying member 60, as illustrated in FIG. 11, where at least one fastening-member 65 may fasten the platform 101 to one end of the swaying member 60 and where the other end of the swaying member 60 may freely be inserted in and out of an opening 63 at the wheels-base 21 to avoid blocking the upwards/downwards tilting movements of the wheels-base 21 when tilted by the tilting mechanism. Additionally, the opening 63 may be wide enough to allow slight rotational tilts along the opening's 63 width (although in general, the platform 101 is not aimed to rotate around the main-axis 30 slight tilting movements in the rotation direction may be enabled).

According to embodiments of the invention, the main-axis-member 10 may be a tube shaped piece that may be inserted through a main-opening 25 in the wheel-base 21 and may bee tangentially interfacing the platform 101 through a ball-shaped bearing that may be seated inside the tube shaped main-axis-member 10.

Since each mechanism is controlled through a different motor, each movement of the platform 101 (levering, tilting and oscillating) may be operated independently—meaning that each mechanism can be operated when at least one of the other mechanisms are off. Each mechanism may be controlled through a different switch 50 enabling to control on/off options of each motor. Additionally, each switch 50 may control the speed of the motor's rotation and/or power level. Additionally, according to embodiments of the invention, the main control box 107 may enable controlling each switch 50 separately and/or at least some of the switches according to, for example, predefined massage or exercising programs.

Additionally, the FSA 100 may be controlled through a remote control, operatively associated with the control box 107 and/or with the switches 50, hence enabling to control the motors' operations from afar. The remote control may enable transmission of operative signaling through any mechanism known in the art whether wireless, wired or both.

According to other embodiments of the invention the FSA 100 may only comprise the oscillating rotation-mechanism or only the oscillating rotation-mechanism with only one of the other mechanisms (the single directional tilting or the levering). Each movement created by each mechanism may serve for exercising, massaging or comfort.

According to some embodiments of the invention the mechanism that may enable the oscillating movement (defined herein as “the oscillation-mechanism”) may be based upon other mechanical principles that may not require a rotation-mechanism and/or bearings 121. For example, the oscillation-mechanism may comprise at least two pistons, positioned at an angle from one another, where the angle is substantially smaller than a hundred and eighty degrees beneath the platform 101 (meaning that the pistons are not seated along the same line) where the platform 101 is affixed at a central point allowing each piston to lift and lower the platform 101 and hence create the oscillation-movement of the platform. The pistons may require calibration of rates, distances, height and the like to technically enable such movement of the platform 101.

According to some embodiments of the invention, the main steps that may be performed by the FSA 100 may be:
supporting the user's feet; and
oscillating the user's feet by enabling to move said feet in a multidirectional movement.

Optionally, if the FSA 100 comprises the tilting-mechanism and the leverage-mechanism further steps may be performed by the FSA 100:
Tilting of the user's feet; and
Lifting and lowering the user's feet.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A feet-supporting apparatus (FSA) comprising of three independent movement-mechanisms enabling to move a feet-supporting platform for massaging of a user's feet when placed upon said platform, wherein said platform is connected to the mechanisms through a main-axis-member defining a main-axis that is substantially perpendicular to a floor-plane upon which the FSA is placed, said mechanisms are:
a leverage mechanism comprising a leverage-motor that enables lifting and lowering said platform along the main-axis;
a tilting mechanism comprising a tilting-motor enabling to tilt said platform in a single tilting direction, rotating along an arched-orbit around a central point along the main-axis;
a rotation-mechanism comprising a rotation-motor enabling to rotate at least two rotating-bearings seated at different distances from the floor-plane and different distances from a wheel-base, which is a plate member connected to the main-axis-member, wherein said rotation-mechanism enables an oscillation movement of said platform;
wherein said oscillation movement is a multidirectional-tilting of said platform that is operatively-independent from the tilting movement and the leverage-movement.

2. The FSA of claim 1 wherein said bearings rotate around their own axis additionally to rotating around the main-axis, wherein said bearings tangentially interface said platform and slide underneath the platform, wherein said different height distances and said rotation movement around the main-axis creates the oscillating-movement of the platform.

3. The FSA of claim 1 wherein said leverage-mechanism is operated independently from the rotation-mechanism and from the tilting-mechanism and the tilting-mechanism is operated independently from the leverage-mechanism and the rotation-mechanism.

4. The FSA of claim 1 wherein said leverage-mechanism further comprises two sets of substantially triangular frames connected through a hinge, wherein each frame comprises two curved-levers that are connected through said hinge, wherein said hinge is connected to the main-axis-member,
wherein the leverage-motor enables rotating at least one rotating-hinge enabling to slide said levers forwards and backwards through a sliding track's opening, whereby said hinge allows the aperture of the frames to increase and decrease thereby lowering and lifting the said platform along the main-axis.

5. The FSA of claim 4 wherein said tilting-mechanism further comprises a tilting shaft rotated by the tilting-motor, wherein said shaft enables rotating a tilting-arm that connects to the main-axis-member enabling to tilt said platform by said rotation.

6. The FSA of claim 5 wherein said rotation-mechanism further comprising at least two cogwheels seated upon a wheel-base, where each cogwheel enables rotating at least one bearing around the main-axis and the cogwheel rotated by the rotation-motor enables rotating the other cogwheels,
wherein said bearings are wheels seated in a bearings-base enabling said bearings to roll within niches designed to hold the bearings wherein said bearings-base is connected to said platform by fastening means.

7. The FSA of claim 1 wherein each motor is operated through a switch that enables controlling each motor that is associated to it.

8. The FSA of claim 7 further comprising a main control box enables operating each switch according to predefined programs.

9. The FSA of claim 8 wherein said control box is operatively associated with a remote control that allows operating said switches.

10. The FSA of claim 1 wherein said platform comprises two wings, wherein a holding-ring supports said ring and wing-holders support the wings.

11. The FSA of claim 1 wherein said main-axis-member is a tube shaped part comprising a ball bearing tangentially interfacing the platform.

12. The FSA of claim 1 further comprising a base-housing enabling to conceal at least some of the inside parts of the FSA.

13. The FSA of claim 1 further comprising an adjustable swaying member that connects to the platform at one end, wherein the other end of the swaying member is freely inserted through an opening at the wheels-base to allow free tilting of the platform by allowing said swaying member to be inserted in and out of the opening as well as tilting along the opening's width.

14. A feet-supporting apparatus (FSA) enabling to oscillate a footrest platform, wherein said oscillation movement is a multidirectional-tilting of said platform said FSA comprising:
the footrest platform allowing a user to place his feet upon said platform;
a main-axis-member that is perpendicular to a floor-plane connected to said platform and to a rotation-mechanism comprising a rotation-motor, a wheels-base, at least two cogwheels and at least two rotation-bearings, wherein said cogwheels are seated upon said wheels-base and are connected to said bearings;
a motor;
wherein said motor enables rotating at least one of the cogwheels enabling to rotate the other cogwheels and said bearings around the main-axis, which is the main axis of the main-axis-member,
wherein said bearings tangentially interface the bottom side of said platform and are of different heights from the wheels-base and from the floor-plane, enabling to create multidirectional tilting of the platform defined as the oscillation movement.

15. A feet-supporting apparatus (FSA) comprising of three independent movement-mechanisms enabling to move a feet-supporting platform of a user's feet when placed upon said platform, wherein said platform is connected to the mechanisms through a main-axis-member defining a main-axis that is substantially perpendicular to a floor-plane upon which the FSA is placed, said mechanisms are:
a leverage mechanism comprising a leverage-motor that enables lifting and lowering said platform along the main-axis;
a tilting mechanism comprising a tilting-motor enabling to tilt said platform in a single tilting direction, rotating along an arched-orbit around a central point along the main-axis; and
an oscillation-mechanism enabling to oscillate said platform, wherein said oscillation-mechanism is operated by a third motor;
wherein said oscillation movement is a multidirectional-tilting of said platform that is operatively-independent from the tilting movement and the leverage-movement.

16. A feet-supporting apparatus (FSA) comprising of an oscillating-mechanisms operated by a motor, wherein said mechanism enabling to move a feet-supporting platform of a user's feet when placed upon said platform, wherein said platform is connected to said mechanism through a main-axis-member defining a main-axis that is substantially perpendicular to a floor-plane upon which the FSA is placed, wherein said oscillation movement is a multidirectional-tilting of said platform.

17. A method for messaging and exercising of a user's feet, using a feet supporting apparatus (FSA) that comprises at least one motor, a footrest platform and a main-axis-member, wherein said member defines a main-axis perpendicular to a floor-plane upon which the FSA is placed, wherein said platform is connected to said member, said method comprising the steps of:
supporting the user's feet, wherein said FSA enables the user to place his feet upon the FSA; and
oscillating the user's feet, wherein said oscillation is a multidirectional tilting movement.

18. The method of claim 17 wherein the oscillation movement of the platform is enabled through a rotation-mechanism comprised by the FSA, wherein said rotation-mechanism comprises a rotation motor, at least one cog-wheel and at least two bearings seated at different distances from said floor-plane and underneath said platform and tangentially interfacing said platform, wherein said motor enables rotating said cog-wheel that enables rotating said bearings around the main-axis of the FSA.

19. The method of claim 17 further comprising the steps of:
tilting of the user's feet, using a tilting-mechanism enabling tilting of said platform in a single-directional tilting, wherein said tilting-mechanism is comprised by said FSA; and
lifting and lowering the user's feet, using a leverage-mechanism comprised by the FSA, wherein said leverage-mechanism enables lilting and lowering of said platform from said floor-plane;
wherein said oscillation-mechanism and leverage-mechanism are independently operated, wherein each mechanism is operated by a different motor.
